(19) United States
(12) Patent Application Publication
(10) Pub. No.: US 2025/0340214 A1
(43) Pub. Date: Nov. 6, 2025

(54) SYSTEMS AND METHODS FOR A COOPERATIVE PERCEPTION SYSTEM

(71) Applicant: The Regents of the University of California, Oakland, CA (US)

(72) Inventors: Zhengwei BAI, Riverside, CA (US); Guoyuan WU, Irvine, CA (US); Matthew BARTH, Riverside, CA (US)

(73) Assignee: The Regents of the University of California, Oakland, CA (US)

(21) Appl. No.: 19/185,085

(22) Filed: Apr. 21, 2025

Related U.S. Application Data
(60) Provisional application No. 63/637,799, filed on Apr. 23, 2024.

(51) Int. Cl. B60W 60/00; G01S 17/42; G01S 17/931; G06T 7/60; G06T 7/73; G06V 10/77; G06V 10/80; G06V 10/82; G06V 20/58

(52) U.S. Cl. CPC B60W 60/001; G01S 17/42; G01S 17/931; G06T 7/60; G06T 7/73; G06V 10/7715; G06V 10/806; G06V 10/82; G06V 20/58; B60W 2556/40; G06T 2200/04; G06T 2207/10028; G06T 2207/20084; G06T 2207/30261

(57) ABSTRACT

Systems and methods for cooperative perception are described. In some examples, the system can comprise a first subsystem comprising a first sensor, a first communication device, and a processor, which can cause the system to: detect, by the first sensor, first point cloud data, apply a data preprocessing process to the first point cloud data to generate first preprocessed sensor data, apply a feature encoding process to the first preprocessed sensor data to generate first feature data; apply an adaptive feature filtering process to the first feature data to select a first subset of features from the first feature data; apply a cooperative feature aggregation process to fuse the first subset of features with other subsets of features, to generate a fused feature map; and apply an object perception model to the fused feature map to generate object perception data.

This application claims priority to U.S. Provisional Patent No. 63/637,799, filed Apr. 23, 2024, which is hereby incorporated be reference in its entirety.

### FIELD OF THE INVENTION

The present disclosure relates generally to systems and methods for a cooperative perception system, and more specifically to systems and methods for an adaptive cooperative perception system related to generating, selecting, and fusing features from point cloud data.

### BACKGROUND

Interest in cooperative perception is growing quickly due to its remarkable performance in improving object perception capabilities. Cooperative perception can fuse hidden feature information from spatially separated entities. Improving cooperative perception is especially crucial for automated driving applications, in which object occlusion is one of the main hurdles to the development of safety and efficiency.

### BRIEF SUMMARY OF THE INVENTION

Disclosed herein are systems and methods for cooperative perception. Existing methods of cooperative perception are based on idealized assumptions. For example, in existing systems and methods, collaborating entities generate and transmit hidden features of the same spatial size for an object. Such generated features, however, are highly idealized and are not representative of the object under real-world conditions. Accordingly, improved systems and methods for cooperative perception are needed. The systems and methods disclosed herein address these needs.

Disclosed herein is a system of adaptive cooperative perception-a system not limited by the idealized assumptions of existing methods. To allow for the cooperative perception under more realistic and challenging conditions, a novel feature encoder, called a pillar attention encoder, is described. A specific pillar attention mechanism extracts the feature data, while considering the feature data's significance for the perception task. An adaptive feature filter is also described. The adaptive feature filter adjusts the size of the feature data to be shared, by considering the importance value of the feature. Experiment data described herein demonstrate that the disclosed methods can outperform existing methods by a large margin.

In some aspects, disclosed herein is a cooperative perception system comprising one or more processors and memory storing instructions that, when executed by the one or more processors, can cause the system to: at a first sensor subsystem comprising a first sensor, a first communication device, and at least one of the one or more processors: detect, by the first sensor, first point cloud data; apply a data preprocessing process to the first point cloud data to generate first preprocessed sensor data; apply a feature encoding process to the first preprocessed sensor data to generate first feature data; apply an adaptive feature filtering process to the first feature data to select a first subset of features from the first feature data, wherein the adaptive feature filtering process determines a number of the features for inclusion in the subset of features based on a communication bandwidth of the first communication device; apply a cooperative feature aggregation process to fuse the first subset of features with one or more other subsets of features corresponding to one or more other respective sensor subsystems, to generate a fused feature map; and apply an object perception model to the fused feature map to generate object perception data.

In some embodiments, applying the data preprocessing process can comprise applying a global coordinate transformation to the first point cloud data and applying the global coordinate transformation to the second point cloud data. In some embodiments, applying the global coordinate transformation can comprise applying a three-dimensional location transformation, a pitch transformation, a roll transformation, and a yaw transformation.

In any of the embodiments herein, applying the feature encoding process can comprise extracting the features into a format that does not rely on a spatial shape of a feature map. In any of the embodiments herein, applying the feature encoding process can comprise applying a multi-head point attention method. In any of the embodiments herein, applying the feature encoding process can comprise: pillarizing a three-dimensional point cloud of the first point cloud data into a plurality of pillars, wherein each point in each pillar of the plurality of pillars includes respective three-dimensional location data and respective intensity data.

In some embodiments, applying the feature encoding process can comprise, for each of the pillars of the plurality of pillars, generating a pillar feature based on a three-dimensional location feature and based on a relative geometric feature. In any of the embodiments herein, applying the feature encoding process comprises, for each pillar of the plurality of pillars, computing a positional embedding via multi-layer perception. In some embodiments, computing the positional embedding can comprise decomposing a core of attention weights between a query point and a key point. In any of the embodiments herein, applying the feature encoding process can comprise, for each pillar of the plurality of pillars, generating a pillar attention feature using a multi-head point attention method.

In any of the embodiments herein, applying the adaptive feature filtering process can comprise selecting the first subset of features from the first feature data based on attention values generated by the feature encoding process. In any of the embodiments herein, the first subset of features can have a first spatial shape and one or more of the other subsets of features can have a second spatial shape different from the first spatial shape. In any of the embodiments herein, applying the cooperative feature aggregation process can comprise applying a two-stream neural network.

In some embodiments, the two-stream feature aggregator can comprise: an infrastructure-based feature aggregator; a vehicle-based feature aggregator; and an infrastructure-vehicle-based feature aggregator.

In any of the embodiments herein, applying the object perception model can comprise performing one or more of: detection, tracking, and segmentation. In any of the embodiments herein, applying the object perception model can comprise applying an anchor-based three-dimensional object detection head to generate an object-level prediction including a three-dimensional location, dimensions of a bounding box, yaw angle, and class information. In any of the embodiments herein, the object perception model can be trained for use with single-sensor-based features.

In any of the embodiments herein, the instructions can cause the system to control one or more autonomous vehicles based on the object perception data. In any of the embodiments herein, the instructions can cause the system to output one or more visual, auditory, or haptic alerts based on the object perception data.

In some aspects, disclosed herein is a non-transitory computer-readable storage medium storing instructions for cooperative perception that, when executed by one or more processors of a cooperative object perception system, can cause the system to: at a first sensor subsystem comprising a first sensor, a first communication device, and at least one of the one or more processors: detect, by the first sensor, first point cloud data; apply a data preprocessing process to the first point cloud data to generate first preprocessed sensor data; apply a feature encoding process to the first preprocessed sensor data to generate first feature data; apply an adaptive feature filtering process to the first feature data to select a first subset of features from the first feature data, wherein the adaptive feature filtering process determines a number of the features for inclusion in the subset of features based on a communication bandwidth of the first communication device; apply a cooperative feature aggregation process to fuse the first subset of features with one or more other subsets of features corresponding to one or more other respective sensor subsystems, to generate a fused feature map; and apply an object perception model to the fused feature map to generate object perception data.

In some embodiments, a cooperative perception method performed by a cooperative perception system comprising one or more processors is provided, the method comprising: at a first sensor subsystem comprising a first sensor, a first communication device, and at least one of the one or more processors: detecting, by the first sensor, first point cloud data; applying a data preprocessing process to the first point cloud data to generate first preprocessed sensor data; applying a feature encoding process to the first preprocessed sensor data to generate first feature data; applying an adaptive feature filtering process to the first feature data to select a first subset of features from the first feature data, wherein the adaptive feature filtering process determines a number of the features for inclusion in the subset of features based on a communication bandwidth of the first communication device; applying a cooperative feature aggregation process to fuse the first subset of features with one or more other subsets of features corresponding to one or more other respective sensor subsystems, to generate a fused feature map; and applying an object perception model to the fused feature map to generate object perception data.

In some embodiments, applying the data preprocessing process comprises applying a global coordinate transformation to the first point cloud data and applying the global coordinate transformation to the second point cloud data.

In some embodiments, applying the global coordinate transformation comprises applying a three-dimensional location transformation, a pitch transformation, a roll transformation, and a yaw transformation.

In some embodiments, applying the feature encoding process comprises extracting the features into a format that does not rely on a spatial shape of a feature map.

In some embodiments, applying the feature encoding process comprises applying a multi-head point attention method.

In some embodiments, applying the feature encoding process comprises: pillarizing a three-dimensional point cloud of the first point cloud data into a plurality of pillars, wherein each point in each pillar of the plurality of pillars includes respective three-dimensional location data and respective intensity data.

In some embodiments, applying the feature encoding process comprises, for each of the pillars of the plurality of pillars, generating a pillar feature based on a three-dimensional location feature and based on a relative geometric feature.

In some embodiments, applying the feature encoding process comprises, for each pillar of the plurality of pillars, computing a positional embedding via multi-layer perception.

In some embodiments, computing the positional embedding comprises decomposing a core of attention weights between a query point and a key point.

In some embodiments, applying the feature encoding process comprises, for each pillar of the plurality of pillars, generating a pillar attention feature using a multi-head point attention method.

In some embodiments, applying the adaptive feature filtering process comprises selecting the first subset of features from the first feature data based on attention values generated by the feature encoding process.

In some embodiments, the first subset of features has a first spatial shape and one or more of the other subsets of features has a second spatial shape different from the first spatial shape.

In some embodiments, applying the cooperative feature aggregation process comprises applying a two-stream neural network.

In some embodiments, the two-stream feature aggregator comprises: an infrastructure-based feature aggregator; a vehicle-based feature aggregator; and an infrastructure-vehicle-based feature aggregator.

The system of any of claims 1-14, wherein applying the object perception model comprises performing one or more of: detection, tracking, and segmentation.

In some embodiments, applying the object perception model comprises applying an anchor-based three-dimensional object detection head to generate an object-level prediction including a three-dimensional location, dimensions of a bounding box, yaw angle, and class information.

In some embodiments, the object perception model is trained for use with single-sensor-based features.

In some embodiments, the instructions cause the system to control one or more autonomous vehicles based on the object perception data.

In some embodiments, the instructions cause the system to output one or more visual, auditory, or haptic alerts based on the object perception data.

In some embodiments, a non-transitory computer-readable storage medium storing instructions for cooperative perception is provided that, when executed by one or more processors of a cooperative object perception system, cause the system to: at a first sensor subsystem comprising a first sensor, a first communication device, and at least one of the one or more processors: detect, by the first sensor, first point cloud data; apply a data preprocessing process to the first point cloud data to generate first preprocessed sensor data; apply a feature encoding process to the first preprocessed sensor data to generate first feature data; apply an adaptive feature filtering process to the first feature data to select a first subset of features from the first feature data, wherein the adaptive feature filtering process determines a number of the features for inclusion in the subset of features based on a communication bandwidth of the first communication device; apply a cooperative feature aggregation process to fuse the first subset of features with one or more other subsets of features corresponding to one or more other respective sensor subsystems, to generate a fused feature map; and apply an object perception model to the fused feature map to generate object perception data.

In some embodiments, a cooperative perception method performed by a cooperative perception system comprising one or more processors is provided, the method comprising: at a first sensor subsystem comprising a first sensor, a first communication device, and at least one of the one or more processors: detecting, by the first sensor, first point cloud data; applying a data preprocessing process to the first point cloud data to generate first preprocessed sensor data; applying a feature encoding process to the first preprocessed sensor data to generate first feature data; applying an adaptive feature filtering process to the first feature data to select a first subset of features from the first feature data, wherein the adaptive feature filtering process determines a number of the features for inclusion in the subset of features based on a communication bandwidth of the first communication device; applying a cooperative feature aggregation process to fuse the first subset of features with one or more other subsets of features corresponding to one or more other respective sensor subsystems, to generate a fused feature map; and applying an object perception model to the fused feature map to generate object perception data.

### INCORPORATION BY REFERENCE

All publications, patents, and patent applications mentioned in this specification are herein incorporated by reference in their entirety to the same extent as if each individual publication, patent, or patent application was specifically and individually indicated to be incorporated by reference in its entirety. In the event of a conflict between a term herein and a term in an incorporated reference, the term herein controls.

### BRIEF DESCRIPTION OF THE DRAWINGS

Various aspects of the disclosed methods, devices, and systems are set forth with particularity in the appended claims. A better understanding of the features and advantages of the disclosed methods, devices, and systems will be obtained by reference to the following detailed description of illustrative embodiments and the accompanying drawings, of which:

FIG. 1 provides an exemplary method for cooperative perception.

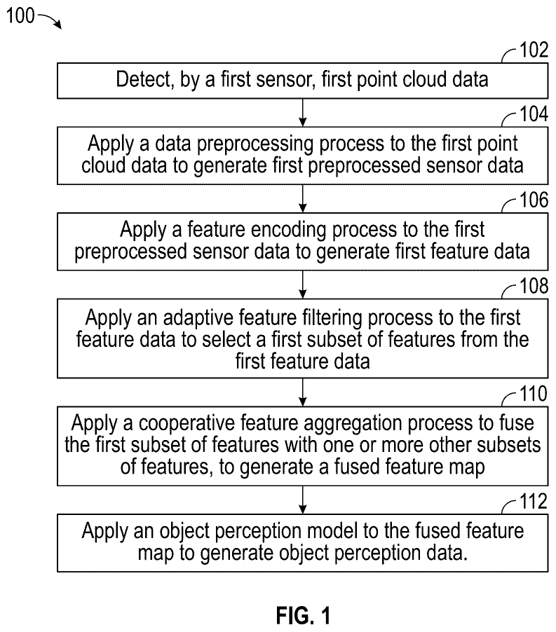

FIG. 2 provides an exemplary flowchart comparing high-level functions of existing cooperative perception systems versus the adaptive cooperative perception systems.

FIG. 3 provides an exemplary flowchart depicting the overall framework of the adaptive cooperative perception system.

FIG. 4 provides an exemplary architecture of the pillar attention encoder.

FIG. 5 depicts a deep neural network backbone for hidden feature extraction.

FIG. 6 depicts an exemplary computing device or system in accordance with one embodiment of the present disclosure.

FIG. 7 depicts an exemplary computer system or computer network, in accordance with some instances of the systems described herein.

FIG. 10 depicts a table showing exemplary specifications of sensors applied in an example.

FIG. 11 depicts a table showing an exemplary Average Precision (AP) performance comparison for different methods under various adaptive transmitting rates ω/Ω of the original feature size.

FIG. 12 depicts a table showing exemplary comparison of performance between Pillar Feature Encoder (PFE) and Pillar Attention Encoder (PAE).

FIG. 13 depicts a table showing exemplary performance data for homogeneous transmitting rates.

### DETAILED DESCRIPTION

Methods and systems for an adaptive cooperative perception system are described. The cooperative perception system can include a processor and memory that store instructions, and a first sensor subsystem comprising a first sensor, a first communication device, and a processor, that cause the system to perform one or more steps. The system can detect first point cloud data using the first sensor. The system can also apply a data preprocessing process to the first point cloud data to generate first preprocessed sensor data. The system can apply a feature encoding process to the first preprocessed sensor data to generate first feature data. The system can then apply an adaptive feature filtering process to the first feature data to select a first subset of features from the first feature data. The adaptive feature filtering process can determine, in the subset of features, a feature for inclusion based on a communication bandwidth of the first communication device. The system can apply a cooperative feature aggregation process to fuse the first subset of features with other subsets of features corresponding to other respective sensor subsystems, to generate a fused feature map. The system can apply an object perception model to the fused feature map to generate object perception data.

Comprehending the surrounding environment is one of the key objectives for computer vision systems, which can be used to empower various autonomous systems such as automated driving vehicles. This requires intelligent entities to be able to sense the environment under different conditions with a comprehensive field of view (FOV). To enhance the perception capability, more sensors with different modalities (e.g., RGBD camera, LiDAR, Radar, etc.) tend to be equipped on these entities to build a panoramic ego-perception system. At the same time, to support the development of these deep-learning models, various types of datasets must be collected and labeled from sensor platforms with different sensor configurations and modalities.

Although remarkable performance has been demonstrated by state-of-the-art perception models to provide for a panoramic perception view, it is still a key challenge to unlock the perception bottleneck caused by physical occlusion and limited sensing range. A recent trend to overcome this challenge is to fuse the perception information from spatially separated entities. The fusing of perception information is referred to as cooperative perception or collaborative perception (CP). For instance, automated vehicles can enhance safety by receiving detection information for occluded pedestrians from an infrastructure-based perception system. Recent CP approaches have demonstrated significant potential for enhancing perception capabilities by improving perception accuracy and enlarging the field of view.

To fuse the perception data from others, a fundamental process for a CP system is to share the sensing data. Different types of sensing data can be shared, which ends up with different types of fusion methods including early fusion, intermediate fusion, and late fusion. Early fusion requires the sharing of raw sensor data to directly enlarge the sensing range while late fusion needs the sharing of perception results, e.g., the detected object list. For intermediate fusion, feature data from a specific layer within the perception model is shared and fused. Among these fusion schemes, intermediate-fusion-based CP approaches have shown a significant performance improvement by fusing the features generated from Deep Neural Networks (DNNs).

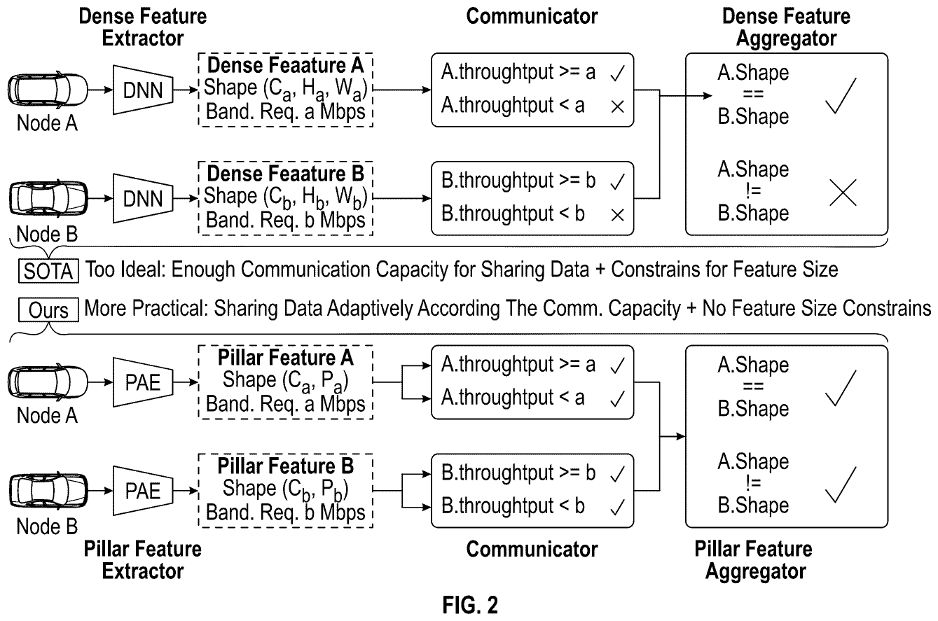

However, these CP approaches bypass a crucial assumption that should not be circumvented in realistic conditions—the adaptivity of the CP models. Specifically, feature data requires a large amount of communication bandwidth for transmission. However, as shown in FIG. 2, current intermediate-fusion-based CP methods require that all CP entities must transmit 100% of their feature data with identical spatial shape to provide for their fused models, which is nearly impractical due to differences in communication capacities for different entities and uncertainties of wireless communication.

As shown in FIG. 2, the systems and methods disclosed herein aim to solve the aforementioned issues by designing a CP approach that allows entities to share feature data adaptively based on the actual communication capacity, and to fuse the feature data with different spatial shapes.

### Proposing a New CP Framework Called Adaptive Cooperative Perception (ACP)

As used herein, the term “framework” may refer to systems, methods, and/or the combination thereof.

The systems and methods herein include an adaptive feature encoder named Pillar Attention Encoder (PAE) which extracts the feature data based on the attention mechanism and adaptively reduces the data amount for sharing based on the exact communication bandwidth.

### Cooperative Perception

The core idea of cooperative perception is to enhance the single-node perception capacity by leveraging the perception information from other spatially separated entities. These entities can be vehicle-based perception nodes and/or infrastructure-based perception nodes. Hence, three types of cooperative perception schemes are categorized: 1) vehicle-based CP, 2) infrastructure-based CP, and 3) vehicle-infrastructure-based CP.

### 1. Vehicle-Based CP

Powered by vehicular networks, Vehicle-to-Vehicle (V2V) cooperative perception has been demonstrated as a promising approach to enhance ego-vehicle perception capabilities through collaborative information sharing among vehicles.

Recent V2V cooperative perception methods significantly explored the usage of deep neural networks for extracting and fusing perception information. For instance, F-Cooper achieved cooperation by 1) extracting hidden features from sensor data via Convolutional Neural Networks (CNNs) at each vehicle, i.e., V-PN; and 2) generating perception results based on cross-vehicle feature data sharing. Additionally, transformers also became an emerging backbone for feature extraction and fusion for cooperative perception.

### 2. Infrastructure-Based CP

Equipped with roadside sensors, transportation infrastructure can be a key factor for unlocking existing bottlenecks for automated driving, especially in a mixed traffic environment via cooperative perception. Due to the innate attributes of the static and higher pose, infrastructure-based perception entities can achieve better sensing range and field-of-view compared with onboard sensing vehicles. Specifically, a single infrastructure-based perception entity equipped with communication devices can be used for enhancing the perception capacity of vulnerable road users or vehicles with connectivity under certain scenarios, such as the recent real-world prototype system Cyber Mobility Mirror and CARMA platform.

Furthermore, combining multiple infrastructure entities can significantly improve the perception range. By leveraging the sensing information from multiple roadside cameras with RGB and Depth (RGB-D) information, existing methods have proposed a cooperative 3D object detection approach to mainly enhance the sensing range and field of view (Arnold et al., (2020), “Cooperative perception for 3D object detection in driving scenarios using infrastructure sensors”, IEEE Transactions on Intelligent Transportation Systems). Specifically, pseudo-point clouds were generated from the RGB-D camera images and the VoxelNet was applied to fuse all the sensing data for generating the cooperative detection results.

### 3. Vehicle-Infrastructure-Based CP

By leveraging both onboard perception and infrastructure-based perception, vehicle-to-everything (V2X) based cooperative object perception is considered the most promising pathway towards tapping the full potential of Cooperative Driving Automation (CDA). Past methods have proposed a V2X-based cooperative perception (CP) method considering the heterogeneity of vehicle and infrastructure nodes and multi-scale receptive fields (Xu et al., (2022), “Vehicle-to-everything cooperative perception with vision transformer”, Computer Vision—ECCV: 17th European Conference, Tel Aviv, Israel, Oct. 23-27, 2022, Proceedings, Part XXXIX, Springer, 2022, 107-124). Some past methods have conducted the Proof-of-Concept of CP in the real world by applying V2X to allow entities to share their sensing results (Lou et al., (2022), “Cooperative Automation Research: CARMA Proof-of-Concept TSMO Use Case Testing: CARMA Cooperative Perception Concept of Operations,” United States. Federal Highway Administration). The program demonstrated the CP system can significantly improve the perception capability of the involved entities.

### Cooperative Feature Sharing

For cooperative perception, one of the most fundamental components is cooperative feature sharing—sharing the feature data among the entities. In terms of the fusion scheme applied in the cooperative perception method, different types of feature data will be generated and shared.

Specifically, cooperative feature fusion can be classified into three categories: 1) Early Fusion, which involves fusing raw data during the preprocessing stage; 2) Late Fusion, which entails fusing perception results during the post-processing stage; and 3) Deep Fusion/Intermediate Fusion, which involves fusing hidden features from the deep neural networks designed for feature extraction and fusion.

For early fusion-based CP methods, raw sensor data is designed to be shared with other entities. This allows for the direct expansion of the sensing range and field of view. By carefully calculating the relative pose information, both LiDAR data and camera data can be converted to a common coordinate by transformation or projection, such as Cooper, AutoCast, and AVR. However, transmitting raw data requires an extremely high communication bandwidth to support cooperative perception in the context of automated driving (e.g., A 64-channel LiDAR with 10 Hz has a data generating rate of around 20 MBps).

Conversely, the data required to be shared by late fusion methods is the semantic textual information, such as the object list containing the 3D object location, rotation, and classification information. For instance, the detection bounding boxes are shared and aligned according to the relative pose estimation, and then these bounding boxes are fused by Non-Maximum Suppression or machine learning-based refining methods. Taking advantage of the semantic data, the bandwidth requirement could be easily achieved for late fusion-based cooperative data sharing. However, these methods usually provide very limited perception accuracy (e.g. in terms of mean Average Precision or mAP), compared with early fusion and deep fusion as mentioned below.

Deep fusion takes the intermediate features as its input and then outputs the features that combine the hidden feature from different entities. A widely applied methodology is to share the hidden feature extracted from a CNN. Recently, transformers have attracted lots of interest to be the deep feature extractor due to their capability to extract features with larger receptive fields.

Although remarkable perception accuracy is demonstrated by deep fusion-based CP methods, compressing intermediate features is indispensable to deploy the system with realistic communication capacities. Data compression techniques, such as CNN-based channel-wise compression or dedicated Encoder-Decoder methods, are commonly used to reduce data volume.

However, these approaches lack the flexibility to support cooperative perception among nodes with distinct communication capacities. Different amounts of data need to be shared for diverse perception nodes. For instance, the fusion of features with varying channels becomes problematic, and employing all different decoders for decompression from distinct encoders is also impractical (e.g., a feature map with size (h, w, c₁) that is going to be fused with a feature map with size (h, w, c₂)).

### Methodology

### Adaptive Cooperative Perception Framework

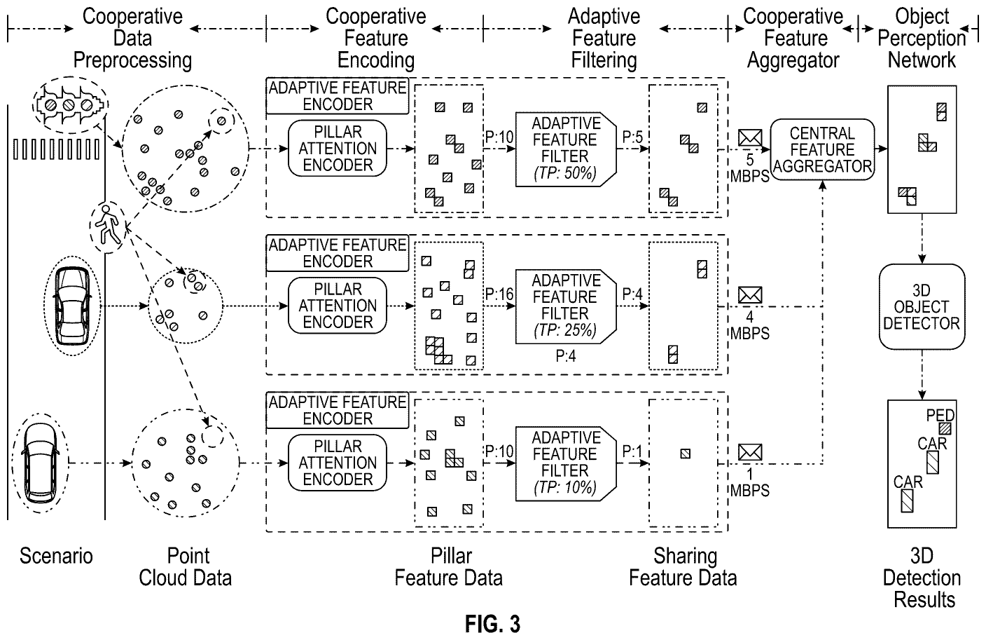

In order to allow for cooperative perception with more dynamic scenarios, the Adaptive Cooperative Perception framework which is composed of five main components as shown in FIG. 3, is proposed. Specifically, the framework can be briefly described as follows:
Cooperative Data Preprocessing: This component aims to apply proper transformation and geo-fencing to prepare the raw sensor data for processing.
Cooperative Feature Encoding: This component aims to extract the feature information from the pre-processed sensor data, which is used for multi-node feature fusion.
Adaptive Feature Filtering: This component aims to adaptively filter the feature for sharing according to the specific communication bandwidth.
Cooperative Feature Aggregator: This component aims to fuse the features retrieved from multiple perception nodes and generate the final feature map for specific downstream tasks, e.g., object detection.
Object Perception Network: This component aims to generate detailed perception results based on specific tasks, such as object detection, tracking, classification, motion detection, etc.

The parts of the adaptive cooperative perception framework are further described herein.

### Cooperative Data Preprocessing

To fuse perception data from spatially separated sensing nodes, coordinate transformation is a necessary step to align the perception information. This alignment can happen in different stages along the perception pipeline. Sensor data can be aligned from its original coordinate to the collaborator's coordinate by applying transformation according to their relative pose estimation. This alignment can also be designed at the end of the perception pipeline, which is mostly used in late-fusion-based CP methods. For feature-based CP methods, the alignment can also be designed after the feature extraction layer.

Aligning the feature after the feature extraction can lead to a spatial matching issue, because the extracted feature maps from different entities are grid-like structures, which are hard to perfectly align with others. Thus, specific matching resolution approaches need to be considered. A natural way to circumvent this challenge is to align the raw data before sending it to the feature extractor. Specifically, rather than calculating the hidden feature directly on data collected with respect to (w.r.t.) vehicle's own coordinate, transforming the raw data w.r.t. the coordinate of the cooperative nodes can finally avoid the occurrence of mismatching of the feature maps.

However, simply transforming the raw data from cooperative nodes to the ego vehicle's coordinate w.r.t. their relative pose estimation can lead to another severe problem under practical scenarios, because vehicles are not only sending out their feature data but also receiving from others. Transformation according to the relative pose can cause an O(N²) complexity for those coordinate transformations (i.e., each vehicle needs to apply N times coordinate transformations according to the relative pose w.r.t. N cooperative nodes).

Thus, for cooperative perception, the systems and methods described herein can use global coordinate transformation rather than relative coordinate transformation to avoid duplicated data transformation. The systems and methods described herein consider point cloud data as an example, because in such an example, LiDAR can be assumed to be the main sensor for cooperative perception. PCD can be assembled on a 3D Cartesian coordinate w.r.t. the geometric center of the LiDAR sensor. Cooperative data preprocessing aims to align PCD from different local coordinates into a global reference coordinate. Specifically, the PCD can be formulated as:

$$L = \{ {[ x , y , z , i ]}^{T} \vert {[ x , y , z ]}^{T} ∈ {R}^{3} , i ∈ [ 0 \text{.0} , 1. ] \} \qquad ( 1 )$$

Then, the 6-D pose estimation for each sensor can be estimated as:

$$SLaP = [ X , Y , Z , P , Θ , R ] \qquad ( 2 )$$

where X, Y, Z, P, Θ, and R represent the 3D location along x-axis, y-axis, z-axis; and the pitch, yaw, and roll angles of the sensors in the global coordinate, respectively.

Next, alignment to the reference coordinate can be calculated by:

$${L}^{E \to G} = [ \begin{matrix}{R}_{X} & 0 \\ 0 & 1\end{matrix} ] \cdot [ \begin{matrix}{R}_{Y} & 0 \\ 0 & 1\end{matrix} ] \cdot [ \begin{matrix}{R}_{Z} & 0 \\ 0 & 1\end{matrix} ] \cdot {L}^{E} + {T}^{E \to G} \qquad ( 3 )$$

where R_{X}, R_{Y}, R_{Z}, and T^{E→G} represent the rotation matrix along x-axis, y-axis, z-axis, and the translation matrix from ego-coordinate to global reference coordinate, respectively. L^{E} and L^{E→G} can represent the raw data before and after the transformation.

### Pillar Attention Encoder

Existing deep fusion-based CP methods require a fixed spatial size of the feature map to allow for the fusion. In other words, the feature data generated from different perception nodes must have the same spatial size so that the deep fusion network can fuse them. This significantly limits the flexibility of the cooperation among perception nodes with different computing power and communication bandwidths. This limitation mainly comes from the use of dense feature data to share their cooperative feature, i.e., a deep neural network is applied to extracting the cooperative feature data which has a fixed number of feature channels, height of the feature map, and width of the feature map, respectively.

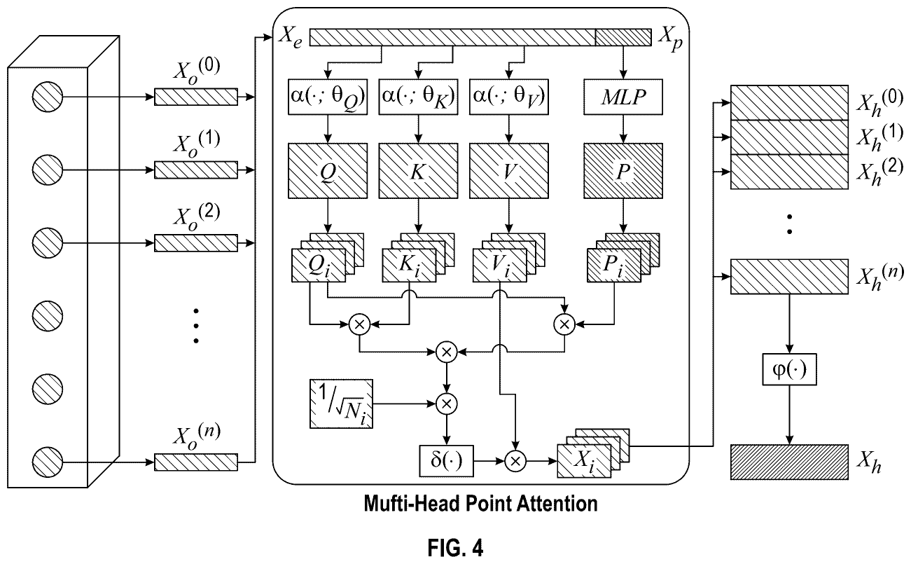

To overcome this limitation, the systems and methods herein describe the Pillar Attention Encoder (PAE). The PAE can extract the cooperative feature into a format that does not rely on the spatial shape of the feature map. Additionally, a multi-head point attention method can be designed to generate stronger representations of the given raw data, as seen, for example, in PCD. The multi-head point attention method can significantly outperform the original CNN encoder. FIG. 4 depicts the main design of the proposed PAE.

### 1. Multi-Head Point Attention

The first step to encode the PCD is to pillarize the 3D point clouds into pillars of points so that the 3D PCD can be reorganized into a pseudo-2D pillar map. The process can be described below as

$$P = \{ P ( h , w ) \vert h ∈ [ - H , + H ] , w ∈ [ - W , + W ] \} \qquad ( 4 )$$

$$P ( {h}_{p} , {w}_{p} = {\{ {[ x , y , z , i ]}_{d} \}}_{d = 1}^{n} , p = 1 , … , {N}_{p} \qquad ( 5 )$$

where P is the set of pillars of points P(h, w) at the 2D voxelized spatial location, and (h, w) in the range of H and W, representing the spatial size of the pillar map. Then, for each pillar of points, every point can be formulated as:

$${X}_{o}^{( d )} = [ x , y , z , i ] , d = 1 , … , n \qquad ( 6 )$$

where x, y, z and i are the 3D locations and the intensity of the reflected point, respectively. So, the set of the point feature in a single pillar can be described as:

$${X}_{o} = {\{ {X}_{o}^{( d )} \}}_{d = 1}^{n} \qquad ( 7 )$$

For each point feature, its original feature

$${X}_{e}^{( d )}$$

can be extended by adding relative geometric features, such as the distance x_{c}, y_{c}, z_{c} to the arithmetic center of all points in the pillar (the d subscript means the d-th point in this pillar) and the geometrical center of the pillar xₚ, yₚ, which are shown as:

$${X}_{e}^{( d )} = [ i , {x}_{c} , {y}_{c} , {z}_{c} , {x}_{p} , y , x , y , z ] , d = 1 , … , n \qquad ( 8 )$$

Specifically, the original 3D location feature are defined as

$${X}_{p}^{( d )}$$

which is mainly used as the position embedding for the point feature vector in the attention calculation.

$${X}_{p}^{( d )} = [ x , y , z ] , d = 1 , … , n \qquad ( 9 )$$

Now, the pillar-wise feature can be generated by combining the point feature mentioned above, which can be described as:

$${X}_{e} = {\{ {X}_{e}^{( d )} \}}_{d = 1}^{n} , {X}_{p} = {\{ {X}_{p}^{( d )} \}}_{d = 1}^{n} \qquad ( 10 )$$

Then, three independent linear layers α(;θ_{Q}), α(;θ_{K}), and α(;θ_{V}) can be designed to convert the original pillar feature Xₑ to Q, K and V as below.

$$Q = α ( {X}_{e} ; {θ}_{Q} ) , K = α ( {X}_{e} ; {θ}_{K} ) , V = α ( {X}_{e} ; {θ}_{V} ) , \qquad ( 11 )$$

The positional embedding can then be calculated via a multi-layer perceptron (MLP) as described by:

$$P = MLP ( {X}_{p} ) \qquad ( 12 )$$

By applying the multi-head self-attention (MHSA) mechanism, Q, K, V and positional embedding P are then divided into Qᵢ, Kᵢ, Vᵢ, and Pᵢ with i=1, . . . , N where N represents the number of heads. Thus, the multi-head point attention can be formulated as:

$${X}_{i} = δ ( \frac{{Q}_{i} {K}_{i}^{T} + {Q}_{i} {P}_{i}}{\sqrt{{N}_{i}}} ) {V}_{i} \qquad ( 13 )$$

where δ( ) is the Softmax operation. Then attention features Xᵢ from all heads are combined and fed into a LayerNorm layer to generate the pillar attention feature \hat{X}ₕ.

$${\hat{X}}_{h} = LayerNorm ( {\{ {X}_{i} \}}_{i = 1}^{N} \qquad ( 14 )$$

The last step is to perform the channel-wise maxout operation p (to the pillar feature \hat{X}ₕ to achieve the final extracted pillar feature Xₕ:

$${\hat{X}}_{h} = {\{ {X}_{h}^{( d )} \}}_{d = 1}^{n} \qquad ( 15 )$$

$${X}_{h} = φ ( {\hat{X}}_{h} ) \qquad ( 16 )$$

### 2. Positional Embedding

Self-attention models are innately designed for calculating the association between the Query and Key. To achieve such models, the position information for each Query is essential for injecting the spatial distance information into the attention calculation. Thus, most of the state-of-the-art attention-based models have their specifically designed positional encoding or positional embedding methods. To be clear, positional encoding refers to the adding of predefined position information (e.g., sinusoidal positional encoding) to the input feature before the MHSA block. Positional embedding, in contrast, means embedding positional information as hidden features, which is learnable while the positional encoding is fixed.

In the context of computer vision tasks, the designing of positional embedding is relatively more abstract than designing it in natural language tasks. The latter provides explicit relative positional information between words, while the former has data that are highly structured.

For LiDAR point cloud data, the positional information can be naturally provided from the raw data, which is the 3D location w.r.t. the sensor's coordinate. Thus, the positional embedding design for the proposed multi-head point attention can follow a natural way by decomposing the core of attention weights εₖⱼ between the Query point k and Key point j, which can be described as:

$${ε}_{kj} = \frac{{X}_{o}^{( k )} {{W}^{Q} ( {X}_{o}^{( j )} {W}^{K} )}^{T}}{\sqrt{{N}_{i}}} \qquad ( 17 )$$

Thus, the positional information can be embedded to εₖⱼ by:

$${ε}_{kj} = \frac{{X}_{o}^{( k )} {{W}^{Q} ( {X}_{o}^{( j )} {W}^{K} )}^{T} + {X}_{o}^{( k )} {{W}^{Q} ( γ ( {X}_{p}^{( kj )} ) )}^{T}}{\sqrt{{N}_{i}}} \qquad ( 18 )$$

where γ(⋅) means the MLP is applied to the natural location feature Xₚ and the positional information is embedded in the term X^{(k)}W^{Q}(γ(X^{(kj)}))^{T}. Furthermore, by extending the equation above from a single point level to all points within a pillar:

$$attention = δ ( \frac{{QK}^{T} + QR}{\sqrt{N}} ) \qquad ( 19 )$$

Then the equation 13 can be obtained by considering the multi-head decomposition and Value V.

### 3. Adaptive Feature Filtering

As mentioned earlier, feature-based CP methods performed remarkable perception accuracy, by fusing the hidden feature from different perception nodes. But the massive amount of feature data makes these models difficult for implementing under real-world conditions, where limited and dynamic communication bandwidths exist. Meanwhile, data compression is helpful in reducing the data amount to transmit with low communication bandwidth. But it is nearly impractical to simply use data compression to handle dynamic situations.

Instead of data compression, another straightforward way to reduce the amount of data is filtering out the data points that have less value to the perception task. The main challenging issue for this ideology is how to define the “value” of data points. Based on the process of self-attention calculation, the “the most eminent attention value” generated from the Pillar Attention Encoder can be used for each pillar feature as the “significance value” of this feature in terms of the perception task.

Additionally, unlike the feature map for the whole frame, pillar features can be easily reassembled and filtered without impacting the integrity of the data representation. In other words, the described Pillar Attention Encoder can inherently support the requirement of adaptive feature filtering.

Thus, the adaptive feature filtering process can be formulated as:

$${v}_{p} = {max}_{1 \leq c \leq C} {X}_{h}^{( p )} , p = 1 , 2 , … , P \qquad ( 20 )$$

where vₚ represents the value of p-th pillar feature Xₕ^{(p)} by max-pooling the most significant value among its channel. Then the data after the adaptive feature filtering X_{AFF} can be described as:

$${X}_{AFF} = \{ {X}_{h}^{( p )} \vert {v}_{p} \geq Ω \} \qquad ( 21 )$$

where Ω represents the threshold of the number of pillar features, which can be dynamically determined by real-time communication conditions.

### Deep Feature Filtering

In the ACP framework, as shown in FIG. 3, a deep feature aggregator is designed to fuse the feature data shared from different perception nodes. In the context of adaptivity, the feature aggregator needs to be able to absorb features with different spatial shapes and features from different numbers of perception nodes. For example, the feature sizes of different vehicles may vary due to the difference in communication capabilities in the onboard devices. Additionally, the number of vehicles or infrastructures that can be involved in the cooperative perception system may be dynamic as well.

To allow feature fusion under dynamic, scalable, and heterogeneous conditions, a two-stream neural network is adopted to fuse pillar features from different perception nodes. The two-stream feature aggregator can consist of three components: an infrastructure-based feature aggregator, a vehicle-based feature aggregator, and an infrastructure-vehicle-based feature aggregator.

For the systems and methods described herein, the feature generated for cooperation is the pillar attention feature X_{AFF} which has a spatial shape of (ω, C), where ω and C represent the exact number of pillar features and the number of channels for each pillar feature, respectively. Specifically, ω≤Ω as Ω is the adaptive threshold according to the communication capacity. Hence, if n_{inf} infrastructure nodes and nᵥₑₕ vehicle nodes are involved in the ACP system, the infrastructure feature fusion stream will take in n_{inf} different X_{AFF} with different spatial sizes. Then these pillar features can be projected to a pseudo-bird-eye-view feature map which has a feature shape of (nif, C, H, W). Then, a maxpooling layer can be applied to aggregate these data along the first dimension and the aggregated feature can have a spatial shape of (l, C, H, W). Similarly, the vehicle-based feature fusion stream can generate another feature map with (l, C, H, W) specifically based on the onboard features. Lastly, the two feature maps can be aggregated by a concatenation layer followed by a convolution layer. The final output can have a normal spatial shape of (C, H, W).

### Object Perception Network

After the feature fusion, perception networks that can be used for single-sensor-based features are theoretically also able to work on the fused feature. In addition, the perception network can be designed for different types of downstream perception tasks, such as detection, tracking, segmentation, etc. The systems and methods described herein applied a widely used 3D object detector consisting of a feature pyramid network and a 3D anchor-based detection head.

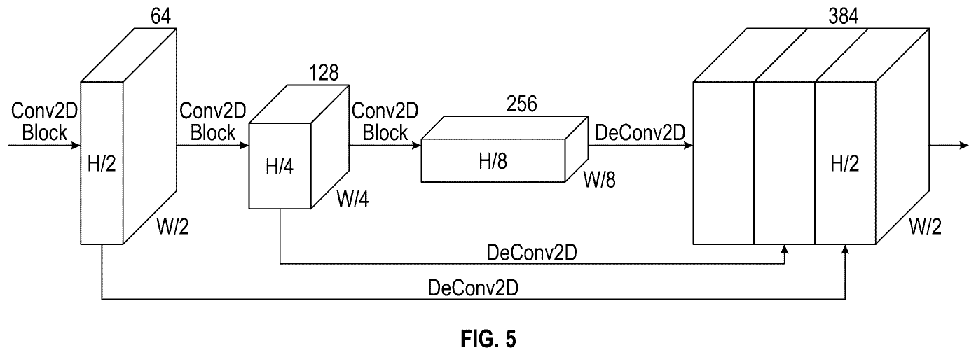

The structure of the detector can be briefly introduced below to help illustrate the whole network structure used. Specifically, FIG. 5 depicts the structure of the feature pyramid network. The feature downsampling blocks consist of convolution layers. Each Conv2D block can consist of one convolution layer with the kernel of (3, 2, 1), followed by several convolution layers with kernels of (3, 1, 1). Specifically, the numbers of convolution layers in each block can be 4, 6, and 6, respectively. The deconvolution layers (DeConv2D) can then be applied to upsample the feature map from different stages of the feature pyramid to include the feature with different receptive fields.

Given that the systems and methods described herein concern mainly object detection, an anchor-based 3D object detection head can be applied to generate the object-level prediction including 3D location, dimensions of the bounding box, yaw angle, and class information.

To conclude, the systems and methods described herein can comprise an adaptive cooperative perception framework. This framework can be designed to allow for cooperative perception under more challenging and realistic conditions. A new feature encoder called, pillar attention encoder (PAE) is described, which allows for adaptive cooperative perception. An adaptive feature filtering method is described for adjusting the amount of features for transmitting. Empowered by the specifically designed pillar attention mechanism, the PAE method can better distinguish the features with their significance of the perception task, thus allowing the feature filter to retain more valuable information within a limited feature size. Experiments demonstrate that the systems and methods described herein significantly outperform baseline methods under various testing cases. Specifically, under a full-range adaptive transmitting condition, the systems and methods described herein can improve the average precision performance for 3D object detection by the range from 8.4% to 13.8% for cars and the range from 4.1% to 6.5% for pedestrians, when compared with the state-of-the-art feature encoder.

### Definitions

Unless otherwise defined, all of the technical terms used herein have the same meaning as commonly understood by one of ordinary skill in the art in the field to which this disclosure belongs.

As used in this specification and the appended claims, the singular forms “a”, “an”, and “the” include plural references unless the context clearly dictates otherwise. Any reference to “or” herein is intended to encompass “and/or” unless otherwise stated.

“About” and “approximately” shall generally mean an acceptable degree of error for the quantity measured given the nature or precision of the measurements. Exemplary degrees of error are within 20 percent (%), typically, within 10%, and more typically, within 5% of a given value or range of values.

As used herein, the terms “comprising” (and any form or variant of comprising, such as “comprise” and “comprises”), “having” (and any form or variant of having, such as “have” and “has”), “including” (and any form or variant of including, such as “includes” and “include”), or “containing” (and any form or variant of containing, such as “contains” and “contain”), are inclusive or open-ended and do not exclude additional, un-recited additives, components, integers, elements, or method steps.

As used herein, ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Similarly, use of a), b), etc., or i), ii), etc. does not by itself connote any priority, precedence, or order of steps in the claims. Similarly, the use of these terms in the specification does not by itself connote any required priority, precedence, or order.

The section headings used herein are for organizational purposes only and are not to be construed as limiting the subject matter described. The description is presented to allow one of ordinary skill in the art to make and use the invention and is provided in the context of a patent application and its requirements. Various modifications to the described embodiments will be readily apparent to those persons skilled in the art and the generic principles herein may be applied to other embodiments. Thus, the present invention is not intended to be limited to the embodiment shown but is to be accorded the widest scope consistent with the principles and features described herein.

The figures illustrate processes according to various embodiments. In the exemplary processes, some blocks are, optionally, combined, the order of some blocks is, optionally, changed, and some blocks are, optionally, omitted. In some examples, additional steps may be performed in combination with the exemplary processes. Accordingly, the operations as illustrated (and described in greater detail below) are exemplary by nature, and, as such, should not be viewed as limiting.

### Computer Systems and Networks

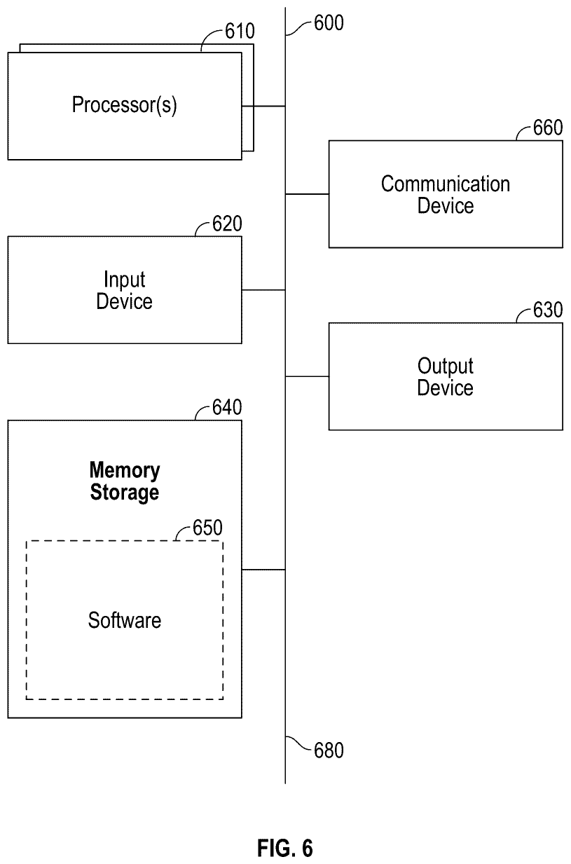

FIG. 6 illustrates an example of a computing device or system in accordance with one embodiment. Device 600 can be a host computer connected to a network. Device 600 can be a client computer or a server. As shown in FIG. 6, device 600 can be any suitable type of microprocessor-based device, such as a personal computer, workstation, server or handheld computing device (portable electronic device) such as a phone or tablet. The device can include, for example, one or more processor(s) 610, input devices 620, output devices 630, memory or storage devices 640, and communication devices 660. Software 650 residing in memory or storage device 640 may comprise, e.g., an operating system as well as software for executing the methods described herein. Input device 620 and output device 630 can generally correspond to those described herein, and can either be connectable or integrated with the computer.

Input device 620 can be any suitable device that provides input, such as a touch screen, keyboard or keypad, mouse, or voice-recognition device. Output device 630 can be any suitable device that provides output, such as a touch screen, haptics device, or speaker.

Storage 640 can be any suitable device that provides storage (e.g., an electrical, magnetic or optical memory including a RAM (volatile and non-volatile), cache, hard drive, or removable storage disk). Communication device 660 can include any suitable device capable of transmitting and receiving signals over a network, such as a network interface chip or device. The components of the computer can be connected in any suitable manner, such as via a wired media (e.g., a physical system bus 680, Ethernet connection, or any other wire transfer technology) or wirelessly (e.g., Bluetooth®, Wi-Fi®, or any other wireless technology).

Software module 650, which can be stored as executable instructions in storage 640 and executed by processor(s) 610, can include, for example, an operating system and/or the processes that embody the functionality of the methods of the present disclosure (e.g., as embodied in the devices as described herein).

Software module 650 can also be stored and/or transported within any non-transitory computer-readable storage medium for use by or in connection with an instruction execution system, apparatus, or device, such as those described herein, that can fetch instructions associated with the software from the instruction execution system, apparatus, or device and execute the instructions. In the context of this disclosure, a computer-readable storage medium can be any medium, such as storage 640, that can contain or store processes for use by or in connection with an instruction execution system, apparatus, or device. Examples of computer-readable storage media may include memory units like hard drives, flash drives and distribute modules that operate as a single functional unit. Also, various processes described herein may be embodied as modules configured to operate in accordance with the embodiments and techniques described above. Further, while processes may be shown and/or described separately, those skilled in the art will appreciate that the above processes may be routines or modules within other processes.

Software module 650 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

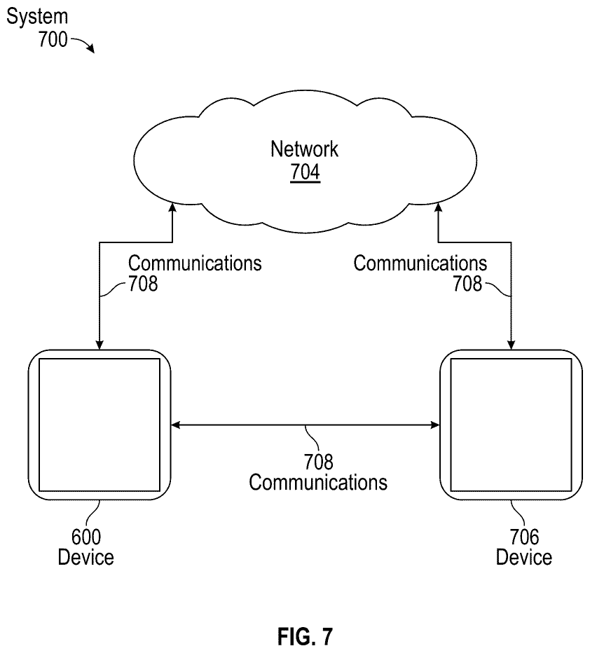

Device 600 may be connected to a network (e.g., network 704, as shown in FIG. 7 and/or described below), which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 600 can be implemented using any operating system, e.g., an operating system suitable for operating on the network. Software module 650 can be written in any suitable programming language, such as C, C++, Java or Python. In various embodiments, application software embodying the functionality of the present disclosure can be deployed in different configurations, such as in a client/server arrangement or through a Web browser as a Web-based application or Web service, for example. In some embodiments, the operating system is executed by one or more processors, e.g., processor(s) 610.

FIG. 7 illustrates an example of a computing system in accordance with one embodiment. In system 700, device 600 (e.g., as described above and illustrated in FIG. 6) is connected to network 704, which is also connected to device 706.

Devices 600 and 706 may communicate, e.g., using suitable communication interfaces via network 704, such as a Local Area Network (LAN), Virtual Private Network (VPN), or the Internet. In some embodiments, network 704 can be, for example, the Internet, an intranet, a virtual private network, a cloud network, a wired network, or a wireless network. Devices 600 and 706 may communicate, in part or in whole, via wireless or hardwired communications, such as Ethernet, IEEE 802.11b wireless, or the like. Additionally, devices 600 and 706 may communicate, e.g., using suitable communication interfaces, via a second network, such as a mobile/cellular network. Communication between devices 600 and 706 may further include or communicate with various servers such as a mail server, mobile server, media server, telephone server, and the like. In some embodiments, Devices 600 and 706 can communicate directly (instead of, or in addition to, communicating via network 704), e.g., via wireless or hardwired communications, such as Ethernet, IEEE 802.11b wireless, or the like. In some embodiments, devices 600 and 706 communicate via communications 708, which can be a direct connection or can occur via a network (e.g., network 704).

One or all of devices 600 and 706 generally include logic (e.g., http web server logic) or are programmed to format data, accessed from local or remote databases or other sources of data and content, for providing and/or receiving information via network 704 according to various examples described herein.

### EXAMPLES

The following examples further demonstrate one skilled in the art how to make and use the methods and systems described herein and are not intended to limit the scope of the claimed invention.

### Example 1

This section provides an example experiment and corresponding data for adaptive cooperation perception, including the pillar attention encoder.

### Experiment Details

### 1. Dataset for Adaptive Cooperative 3D Object Detection

The “CARTI” (i.e., CARla-kiTtI) platform was applied to collect the LiDAR sensor data and 3D ground truth labels for training and testing the models. Specifically, two infrastructure nodes and three vehicle nodes were deployed for data collection. A total of 9,179 frames of 3D point clouds were collected (45,895 samples if counting perception nodes in all frames), including 3,059 frames for training, 3,060 frames for validation, and 3,060 frames for testing.

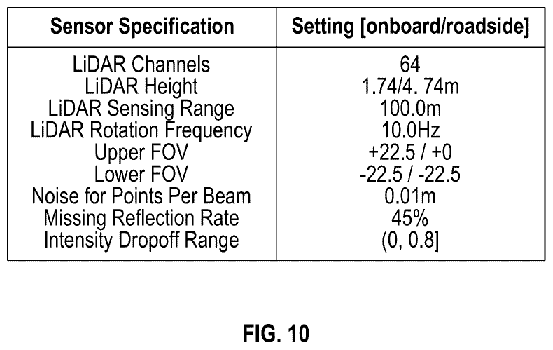

The specification of sensors applied is shown in the table in FIG. 10 and two different LiDAR settings were used based on previous work in the real world. To make the simulated point cloud data closer to the realistic conditions, the simulated LiDAR was configured with certain noise settings including standard deviation of the noise for points per beam, missing reflection rate, and intensity dropoff range, which were also specified in the table in FIG. 10

### 2. Training Details

The training and testing platform consisted of an Intel® Core™ i7-10700K CPU and an NVIDIA RTX 3090 GPU. The training pipeline was designed with 160 epochs with batchsize of 2. The voxel size was set as [0.23 m, 0.23 m, 6.00 m] and the maximum number of pillars per node NP was set as 15,000. Specifically, during the training stage, ω—the number of pillar features that were able to transmit with others—is randomly varying from the range [0.010, 1.000]. It was noted that different nodes in the same frame were assigned various ω values to emulate the dynamic conditions in the real world.

### 3. Evaluation Details

It is noticeable that the evaluations under different communication bandwidth limitations (i.e., different ω) were conducted without any further fine-tuning. This zero-shot setting allowed for the evaluating of the model under more critical but realistic conditions.

The detection performance was measured with Average Precision (AP) at Intersection-over-Union (IoU) thresholds of 0.7 for cars and 0.25 for pedestrians. Furthermore, based on the Minimum number of Points (MP) reflected by the ground target, each evaluation class was further divided into three categories: Easy (MP≥10), Medium (MP≥5), and Hard (MP≥1), respectively, to investigate the performance of CP methods at different difficulty levels.

To evaluate the models in a dynamic environment, the models with several different dynamic ranges of communication capacities were tested. To make the evaluation representative and efficient, the models were evaluated under different conditions, including: ω∈[0.01Ω, 0.10Ω], ω∈[0.10Ω, 0.20Ω], ω∈[0.20Ω, 0.30Ω], ω∈[0.30Ω, 0.40Ω], ω∈[0.40Ω, 0.50Ω], and ω∈[0.50Ω, 1.00Ω]. None of the models were fine-tuned by any of the thresholds designed above, while testing.

### 4. Feature Encoder Baselines

To compare the performance, one of the most popular feature encoders for PCD-based object detectors—Pillar Feature Encoder (PFE)—was used as the baseline, which was proposed in PointPillar. Additionally, in the later experiment, the method was be noted as PAE (Pillar Attention Encoder).

### 5. Adaptive Filtering Baselines

Since adaptive filtering is a new concept in this field, several heuristic feature filtering methods were considered including:
K-Nearest Neighbor (KNN): Sorting the features with respect to (w.r.t.) the distance between the pillar feature and the location of the sensor itself. Top-K nearest features were selected, because the model likely has higher confidence in the feature closer to it.
K-Farthest Neighbor (KFN): A converse method w.r.t. the KNN by selecting the farthest feature first.
K-Random Sampling (KRS): A random sampling method among the pillar features.

Specifically, for calculating the distance between the spatial location of the feature cell and the sensor, Manhattan Distance was applied to calculating the priorities with better computational efficiency (when compared with Euclidean Distance), which was defined as below:

$${D}_{m} = \vert {x}_{p} - {x}_{s} \vert + \vert {y}_{p} - {y}_{s} \vert \qquad ( 22 )$$

where Dₘ is the Manhattan distance between the feature location (xₚ, yₚ) and the sensor location (xₛ, yₛ). Specifically, the adaptive filtering method was noted as KFV (K-Feature Value).

### Evaluation and Analysis

In this section, dynamic feature-sharing approaches were evaluated from two perspectives: 1) quantitative results and analysis to show the numerical results of the methods; and 2) qualitative results and analysis to visualize the performance and interpret the methods. All models were evaluated in terms of 3D object detection for cars and pedestrians. The average precision (AP) was applied to assess the performance.

### 1. Quantitative Results and Analysis

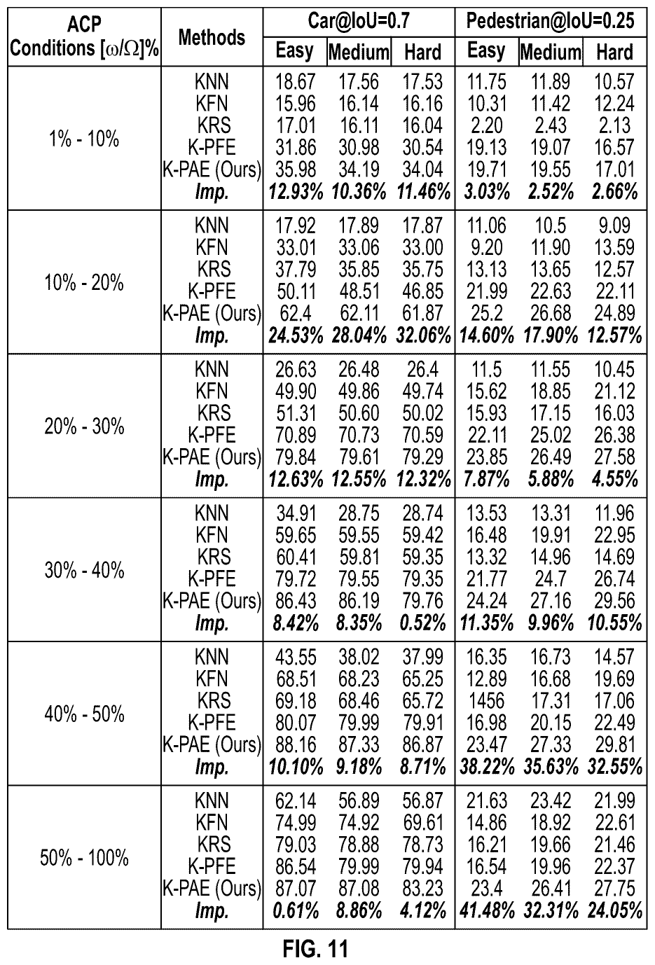

The table in FIG. 11 shows the AP performance comparison for different methods under various adaptive transmitting rates ω/Ω of the original feature size. The table also highlights the improvement of the method compared with the K-PFE method which uses the PFE as the encoder and the KFV as filter. It shows that the method (K-PAE) outperformed the baseline under all testing scenarios.

Specifically, with 10%-20% transmitting rates, the systems and methods described herein can improve the AP for car detection by 24% to 32% approximately compared with the baseline. Under the 50% to 100% transmitting rates, the systems and methods described herein can improve the AP for pedestrians by 24% to 41% approximately.

For adaptive feature filters, from the table in FIG. 11, the KFV method significantly outperformed others (KNN, KFN, and KRS) by a large margin. The performance improvement can be explained, because the features with higher values can have higher dominance for the perception results. Thus, prioritizing the features with higher values and transmitting them before the features with lower values can lead to better performance.

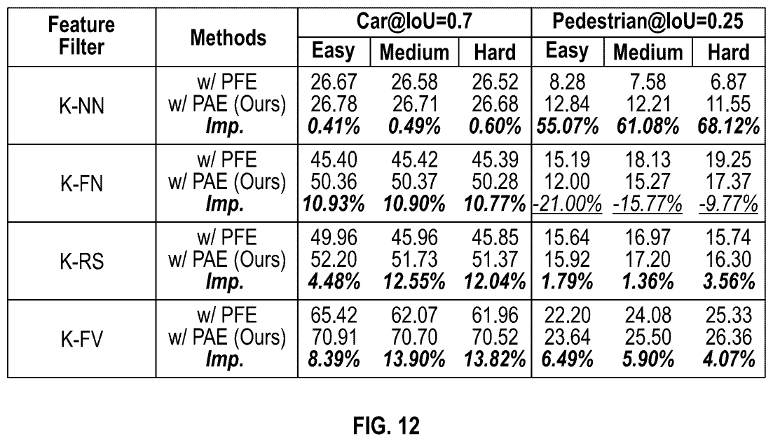

To further compare the performance between PFE and the PAE, both encoders for all different filtering methods were tested, as shown in the table in FIG. 12. In the table in FIG. 12, for three of the four feature filtering methods, PAE can improve the performance by up to 68% with testing under the fully dynamic environment with 1%-100% transmitting rates.

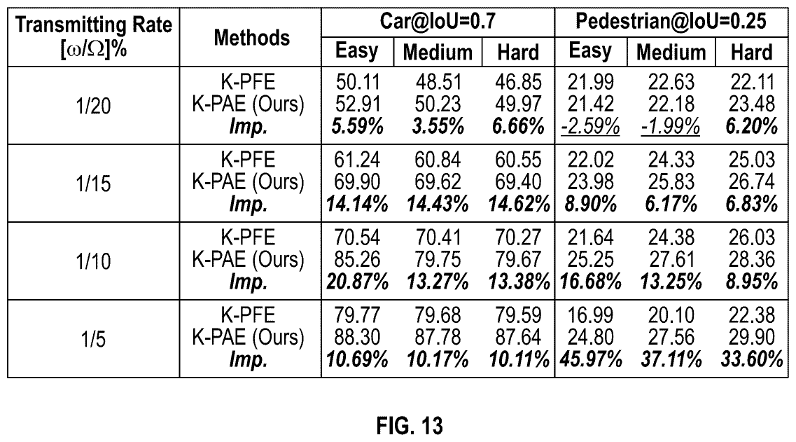

Besides the dynamic environment in which different nodes may have different transmitting rates, the methods were tested under homogeneous transmitting rates as shown in the table in FIG. 13. By transmitting 1/20 out of the original features, the systems and methods described herein can outperform the PFE method by 6+% under the Hard condition for both car and pedestrian detection. Under the transmitting rate of 1/15, 1/10, 1/5 conditions, the systems and methods described herein can improve the performance by 10% to 21% for car detection and 6% to 46% for pedestrian detection, respectively.

Additionally, the upper bound of the detection performance of the model was 90.90% when ω=Ω, which was 15,000. According to the table in FIG. 13, the systems and methods described herein can achieve 97% and 94% of the AP performance while reducing the transmitting data by 5× and 10×. For the PFE baseline, the AP performance changed by 88% and 78%, respectively.

### 2. Qualitative Results and Analysis

To further investigate the performance of different ACP methods, filtered features and 3D object detection results were visualized. Heatmaps were applied to visualize the most eminent feature value of the filtered feature for different methods. Literally, each node should have its own feature map visualization, but for conciseness, the features from nodes were combined with the same type, e.g., features from all vehicle nodes were combined into one feature map for visualization. This operation was only used for efficient visualization and each point in the visualization represents a pillar feature.

By comparing the visualized feature maps, several interesting findings can be identified. The distribution of the filtered features shows a strong correlation with the corresponding adaptive feature filtering methods. For instance, filtered features from the KNN method are mainly the features around the sensors, while the KFN-based filtered features are mainly the features that are away from the sensors. But based on the numerical evaluation mentioned above, looking for faraway features seemed to have a better performance than looking for nearby features, which could be counter-intuitive. The filtered features from KRS were distributed like down-sampled point cloud data.

On the other hand, features filtered by KFV-based methods were more concentrated on the region of interest (Rol), the area where the features were targeted for transmission. Specifically, the features of KFV-PFE and KFV-PAE are mainly the features generated from the PCD reflected by the objects targeted for detection. Thus, by looking at the visualization, KFV-based methods have evidently better detection results than the three baselines.

To interpret the performance improvement of the PAE compared with the PFE, the filtered feature map was visualized with zoom-in windows for KFV-PAE and KFV-PFE. These zoom-in windows demonstrated that the PAE method can better differentiate the features that were very close to the Rol features, and the features coming from the objects. PAE had much fewer features left near the objects. However, the PFE remained significantly more features on the ground that were valueless for the perception task and would waste the bandwidth for sending the worthless information. Sending fewer number of invaluable features, the PAE method could transmit more valuable features to support better perception performance. For instance, in this area, PFE has no features left while the PAE does for Rol objects. In other words, the PAE can allow the ACP methods to filter features better by mainly focusing on the innate significance of the features rather than their spatial distributions.

What is claimed is:

1. A cooperative perception system comprising one or more processors and memory storing instructions that, when executed by the one or more processors, cause the system to:
at a first sensor subsystem comprising a first sensor, a first communication device, and at least one of the one or more processors:
detect, by the first sensor, first point cloud data;
apply a data preprocessing process to the first point cloud data to generate first preprocessed sensor data;
apply a feature encoding process to the first preprocessed sensor data to generate first feature data;
apply an adaptive feature filtering process to the first feature data to select a first subset of features from the first feature data, wherein the adaptive feature filtering process determines a number of the features for inclusion in the subset of features based on a communication bandwidth of the first communication device;
apply a cooperative feature aggregation process to fuse the first subset of features with one or more other subsets of features corresponding to one or more other respective sensor subsystems, to generate a fused feature map; and
apply an object perception model to the fused feature map to generate object perception data.

2. The system of claim 1, wherein applying the data preprocessing process comprises applying a global coordinate transformation to the first point cloud data and applying the global coordinate transformation to the second point cloud data.

3. The system of claim 2, wherein applying the global coordinate transformation comprises applying a three-dimensional location transformation, a pitch transformation, a roll transformation, and a yaw transformation.

4. The system of claim 1, wherein applying the feature encoding process comprises extracting the features into a format that does not rely on a spatial shape of a feature map.

5. The system of claim 1, wherein applying the feature encoding process comprises applying a multi-head point attention method.

6. The system of claim 1, wherein applying the feature encoding process comprises:
pillarizing a three-dimensional point cloud of the first point cloud data into a plurality of pillars, wherein each point in each pillar of the plurality of pillars includes respective three-dimensional location data and respective intensity data.

7. The system of claim 6, wherein applying the feature encoding process comprises, for each of the pillars of the plurality of pillars, generating a pillar feature based on a three-dimensional location feature and based on a relative geometric feature.

8. The system of claim 6, wherein applying the feature encoding process comprises, for each pillar of the plurality of pillars, computing a positional embedding via multi-layer perception.

9. The system of claim 8, wherein computing the positional embedding comprises decomposing a core of attention weights between a query point and a key point.

10. The system of claim 6, wherein applying the feature encoding process comprises, for each pillar of the plurality of pillars, generating a pillar attention feature using a multi-head point attention method.

11. The system of claim 1, wherein applying the adaptive feature filtering process comprises selecting the first subset of features from the first feature data based on attention values generated by the feature encoding process.

12. The system of claim 1, wherein the first subset of features has a first spatial shape and one or more of the other subsets of features has a second spatial shape different from the first spatial shape.

13. The system of claim 1, wherein applying the cooperative feature aggregation process comprises applying a two-stream neural network.

14. The system of claim 13, wherein the two-stream feature aggregator comprises:
an infrastructure-based feature aggregator; a vehicle-based feature aggregator; and
an infrastructure-vehicle-based feature aggregator.

15. The system of claim 1, wherein applying the object perception model comprises performing one or more of: detection, tracking, and segmentation.

16. The system of claim 1, wherein applying the object perception model comprises applying an anchor-based three-dimensional object detection head to generate an object-level prediction including a three-dimensional location, dimensions of a bounding box, yaw angle, and class information.

17. The system of claim 1, wherein the object perception model is trained for use with single-sensor-based features.

18. The system of claim 1, wherein the instructions cause the system to control one or more autonomous vehicles based on the object perception data.

19. The system of claim 1, wherein the instructions cause the system to output one or more visual, auditory, or haptic alerts based on the object perception data.

20. A non-transitory computer-readable storage medium storing instructions for cooperative perception that, when executed by one or more processors of a cooperative object perception system, cause the system to:
at a first sensor subsystem comprising a first sensor, a first communication device, and at least one of the one or more processors:
detect, by the first sensor, first point cloud data;
apply a data preprocessing process to the first point cloud data to generate first preprocessed sensor data;
apply a feature encoding process to the first preprocessed sensor data to generate first feature data;
apply an adaptive feature filtering process to the first feature data to select a first subset of features from the first feature data, wherein the adaptive feature filtering process determines a number of the features for inclusion in the subset of features based on a communication bandwidth of the first communication device;
apply a cooperative feature aggregation process to fuse the first subset of features with one or more other subsets of features corresponding to one or more other respective sensor subsystems, to generate a fused feature map; and
apply an object perception model to the fused feature map to generate object perception data.

21. A cooperative perception method performed by a cooperative perception system comprising one or more processors, the method comprising:
at a first sensor subsystem comprising a first sensor, a first communication device, and at least one of the one or more processors:
detecting, by the first sensor, first point cloud data;
applying a data preprocessing process to the first point cloud data to generate first preprocessed sensor data;
applying a feature encoding process to the first preprocessed sensor data to generate first feature data;
applying an adaptive feature filtering process to the first feature data to select a first subset of features from the first feature data, wherein the adaptive feature filtering process determines a number of the features for inclusion in the subset of features based on a communication bandwidth of the first communication device;
applying a cooperative feature aggregation process to fuse the first subset of features with one or more other subsets of features corresponding to one or more other respective sensor subsystems, to generate a fused feature map; and
applying an object perception model to the fused feature map to generate object perception data.
